(19) United States
(12) Patent Application Publication
(10) Pub. No.: US 2025/0334251 A1
(43) Pub. Date: Oct. 30, 2025

(54) HIGH BRIGHTNESS LAMP MIRROR

(71) Applicant: GUANGZHOU ZHUO RUI SMART HOME TECHNOLOGY CO., LTD, GUANGZHOU (CN)

(72) Inventors: Jiazheng CHENG, Guangzhou (CN); Donglian LIN, Guangzhou (CN); Zhigang FENG, GUANGZHOU (CN)

(21) Appl. No.: 19/192,551

(22) Filed: Apr. 29, 2025

(30) Foreign Application Priority Data
Apr. 29, 2024 (CN) 202420915036.1

(51) Int. Cl. F21V 7/00; A47G 1/02; F21V 9/40; F21V 14/00; F21V 14/02; F21V 29/90; F21V 33/00; F21W 121/00; F21W 131/302; F21Y 115/10

(52) U.S. Cl. CPC F21V 7/0016; A47G 1/02; F21V 9/40; F21V 14/003; F21V 14/02; F21V 29/90; F21V 33/004; A47G 2200/08; F21W 2121/00; F21W 2131/302; F21Y 2115/10

(57) ABSTRACT

The present application discloses to a high brightness lamp mirror, which includes: a mirror body, wherein a light-transmitting area is provided on the mirror body; a back light frame provided on a back surface of the mirror body, wherein, the back light frame includes a top plate and a back plate; the top plate is a light-transmissive plate, the top plate is provided between a mirror body contour edge and an outer edge of the light-transmitting area of the mirror body; the back plate is connected to the top plate, the top plate and the back plate form a light-emitting cavity covering the mirror body, a light-emitting opening is provided on one side of the light-emitting cavity near the mirror body; a lamp strip provided in the light-emitting cavity of the back light frame

### CROSS-REFERENCE TO RELATED APPLICATIONS

This application claims the priority of Chinese Patent Application No. CN202420915036.1, filed on Apr. 29, 2024, the entire content of which is hereby incorporated by reference.

### FIELD OF TECHNOLOGY

The present application relates to the technical field of mirrors with lighting function, and in particular to a high brightness lamp mirror.

### BACKGROUND

With gradual development of video platforms, there is an increasing demand for makeup mirrors, fill lights, etc. Therefore, lamp mirrors that combine both lighting and mirror functions have become highly important. A traditional lamp mirror simply combines a mirror and a lamp together, and front light directly shining on users is too harsh. This affects the users to observe themselves in the mirror. Also, a significant contrast between strong illuminating light and ambient light causes significant impact on the users' eyes and vision. To this end, existing lamp mirrors add back light that illuminates a surrounding environment to reduce a contrast between the front light and the ambient light, softening the front light and improving user experience.

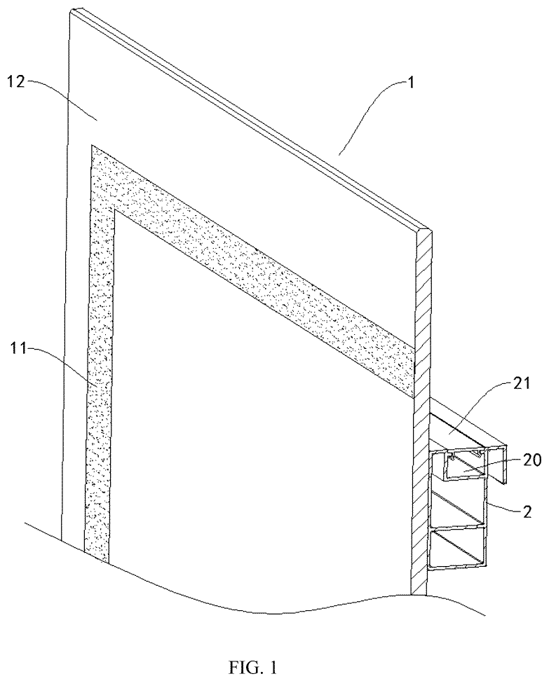

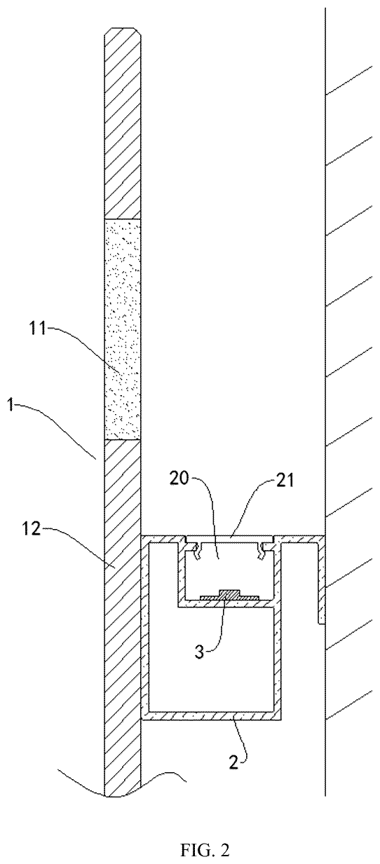

Please refer to FIG. 1 and FIG. 2. An existing lamp mirror includes a mirror body 1, a back light frame 2 and a lamp strip 3. A light-transmissive light-transmitting area 11 is provided on the mirror body 1. A light-emitting cavity 20 is provided in the back light frame 2. The lamp strip 3 is provided in the light-emitting cavity 20. In this structure, light beams emitted by the lamp strip 3 firstly transmits through a top plate 21 of the back light frame 2, and another part of the light beams exits from the light-transmitting area 11 of the mirror body 1 to form a front lighting effect; another part of the light beams exits from a periphery of a back surface of the mirror body 1 to form a back lighting effect.

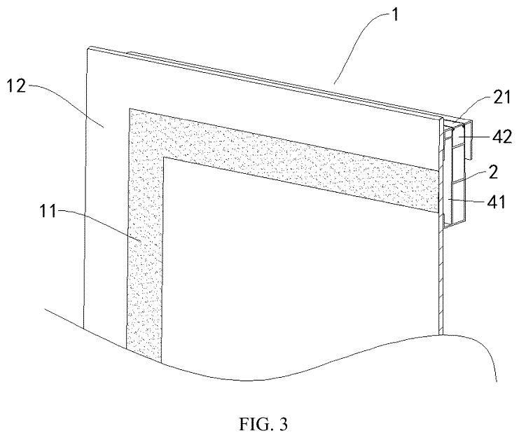

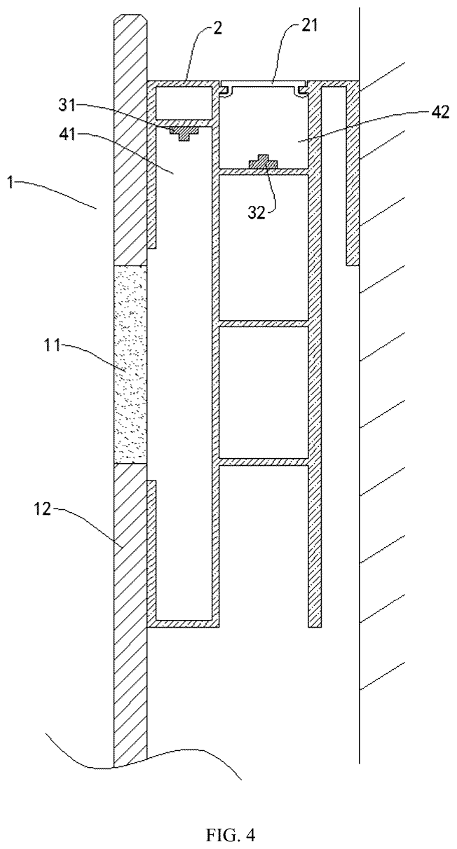

Please refer to FIG. 3 and FIG. 4. Another existing lamp mirror includes a mirror body 1, a back light frame, a front lamp strip 31 and a back lamp strip 32. A light-transmissive light-transmitting area 11 is provided on the mirror body 1. A first light-emitting cavity 41 and a second light-emitting cavity 42 isolated from each other are provided in the back light frame 2. The front lamp strip 31 is provided in the first light-emitting cavity 41, the back lamp strip 32 is provided in the second light-emitting cavity 42. In this structure, a light beam emitted by the front lamp strip 31 exits through the light-transmitting area 11 of the mirror body 1, forming a front lighting effect; a light beam emitted by the back lamp strip 32 transmits through a top plate 21 of the back light frame 2 and exits from a periphery of a back surface of the mirror body 1, forming a back lighting effect.

### SUMMARY

According to an aspect of the present application, a high brightness lamp mirror is disclosed and includes:
a mirror body, wherein a light-transmitting area is provided on the mirror body;
a back light frame provided on a back surface of the mirror body, wherein, the back light frame includes a top plate and a back plate; the top plate is a light-transmissive plate, the top plate is provided between a mirror body contour edge and an outer edge of the light-transmitting area of the mirror body; the back plate is connected to the top plate, the top plate and the back plate form a light-emitting cavity covering the mirror body, a light-emitting opening is provided on one side of the light-emitting cavity near the mirror body;
a lamp strip provided in the light-emitting cavity of the back light frame; wherein, a part of light beams emitted by the lamp strip exits from the light-transmitting area of the mirror body through the light-emitting opening, forming a front lighting effect; and another part of the light beams emitted by the lamp strip exits from the mirror body contour edge through the top plate along the back surface of the mirror body, forming a back lighting effect.

### BRIEF DESCRIPTION

FIG. 1 is a perspective view of a structure of an existing lamp mirror;

FIG. 2 is a side view of the structure of the lamp mirror in FIG. 1;

FIG. 3 is a perspective view of a structure of another existing lamp mirror;

FIG. 4 is a side view of the structure of the lamp mirror in FIG. 3;

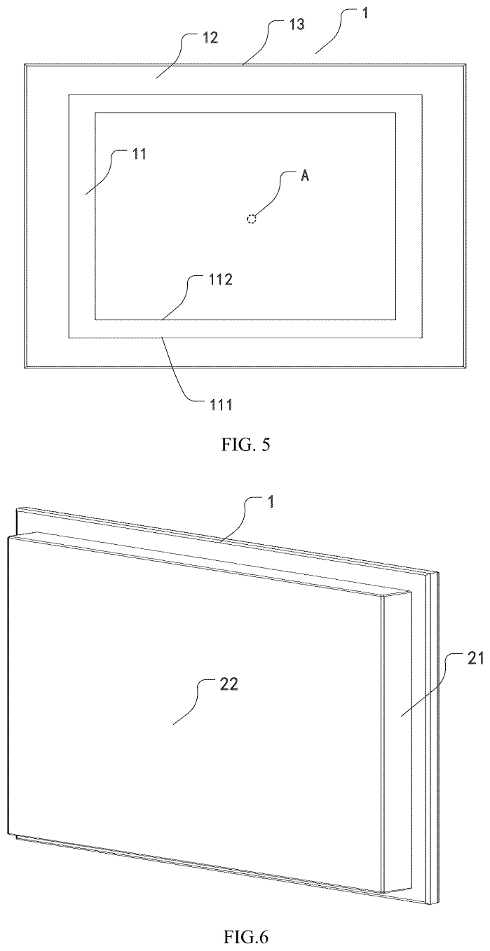

FIG. 5 is a front structural view of a structure of a high brightness lamp mirror in Embodiment 1 of the present application;

FIG. 6 is a rear perspective view of a structure of the high brightness lamp mirror in Embodiment 1 of the present application;

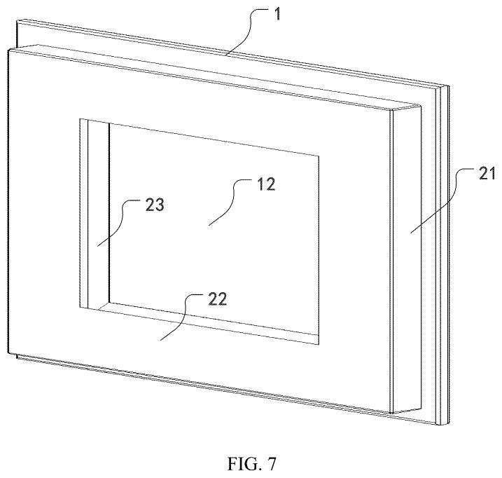

FIG. 7 is a rear perspective view of another structure of the high brightness lamp mirror in Embodiment 1 of the present application;

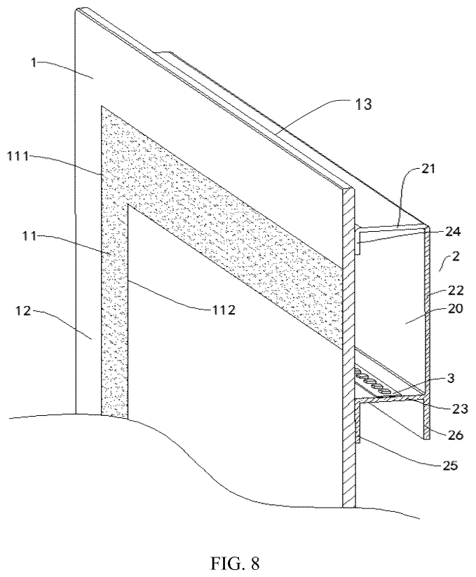

FIG. 8 is a front perspective view of the high brightness lamp mirror in FIG. 7;

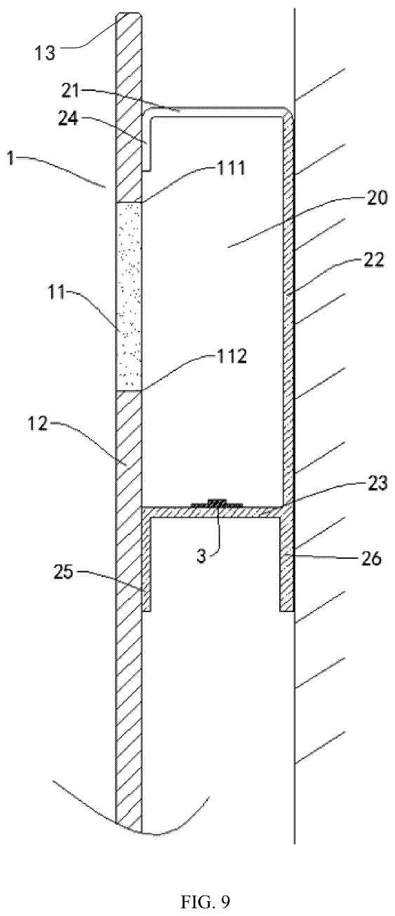

FIG. 9 is a cross-sectional view of the high brightness lamp mirror in FIG. 7;

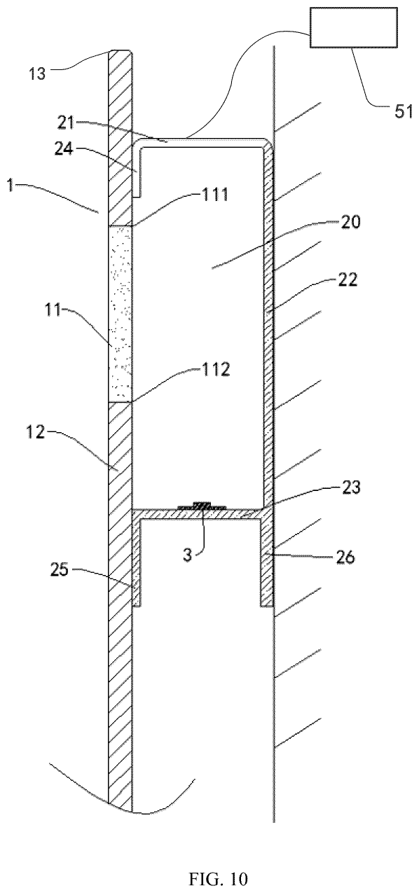

FIG. 10 is a cross-sectional view of a structure of a high brightness lamp mirror in Embodiment 2 of the present application;

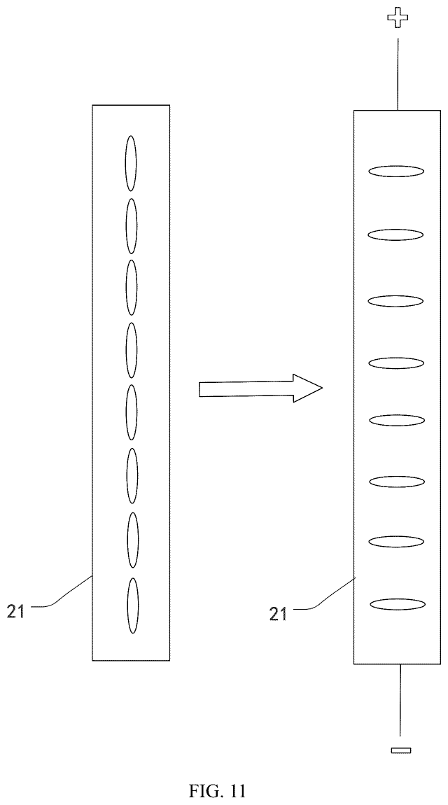

FIG. 11 is a schematic diagram of a principle of a top plate adjustment unit in the high brightness lamp mirror in Embodiment 2 of the present application, which adjusts a transmittance of a top plate by voltage;

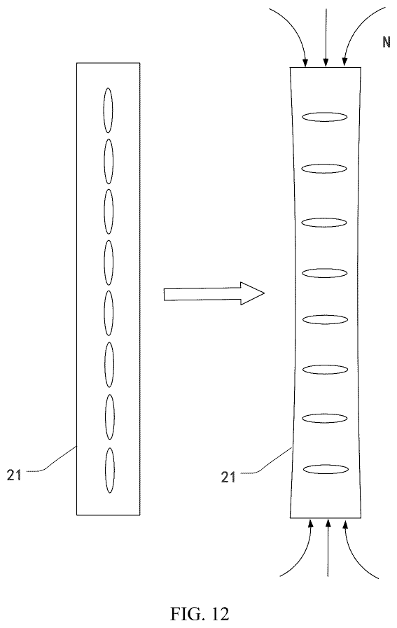

FIG. 12 is a schematic diagram of a principle of a top plate adjustment unit in the high brightness lamp mirror in Embodiment 2 of the present application, which adjusts a transmittance of a top plate by pressure;

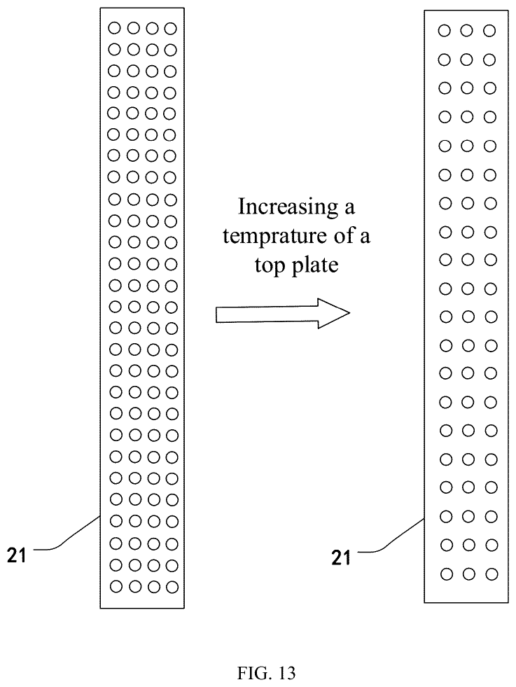

FIG. 13 is a schematic diagram of a principle of a top plate adjustment unit in the high brightness lamp mirror in Embodiment 2 of the present application, which adjusts a transmittance of a top plate by temperature;

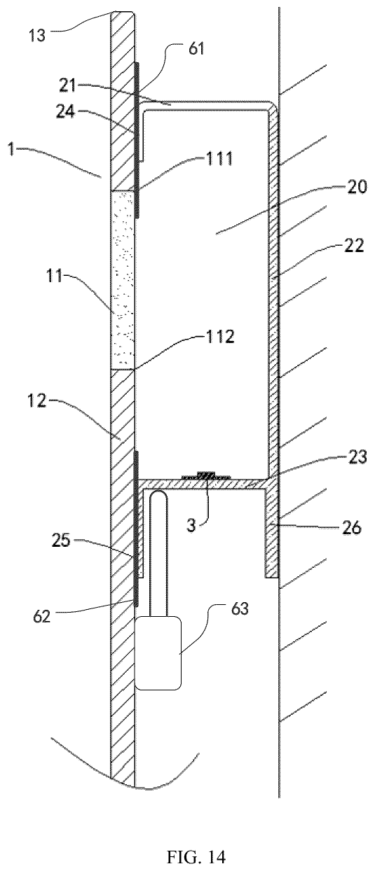

FIG. 14 is a cross-sectional view of a structure of a high brightness lamp mirror in Embodiment 3 of the present application;

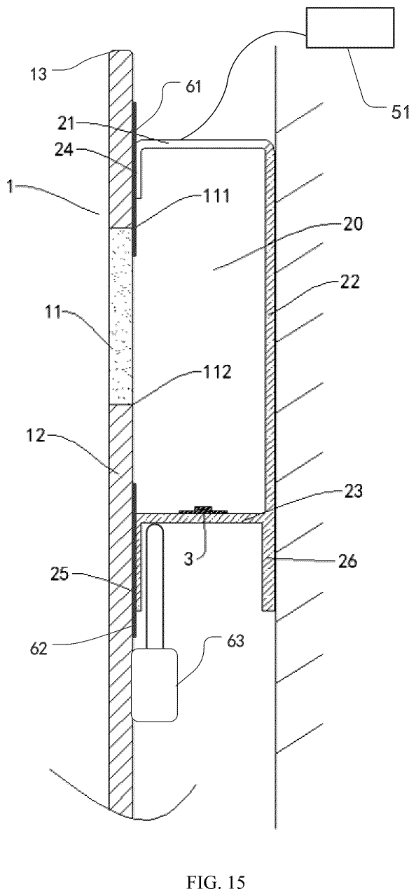

FIG. 15 is a cross-sectional view of a structure of a high brightness lamp mirror in Embodiment 4 of the present application;

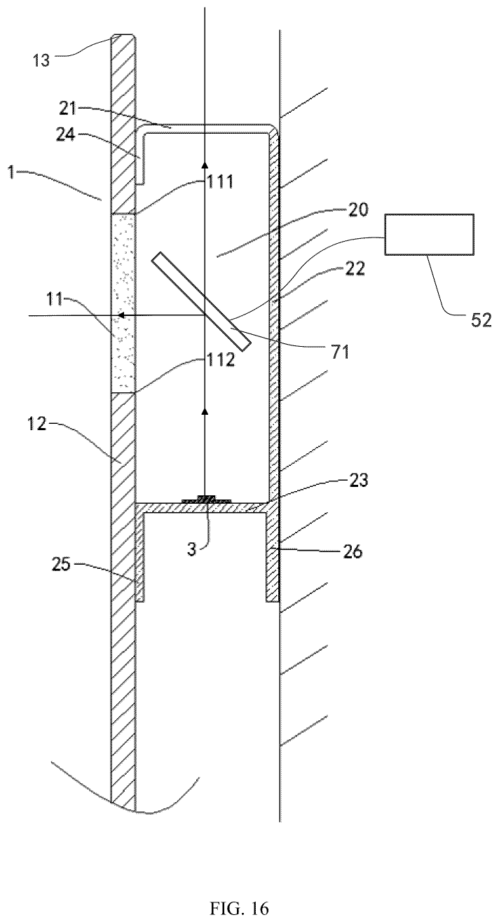

FIG. 16 is a cross-sectional view of a structure of a high brightness lamp mirror in Embodiment 5 of the present application;

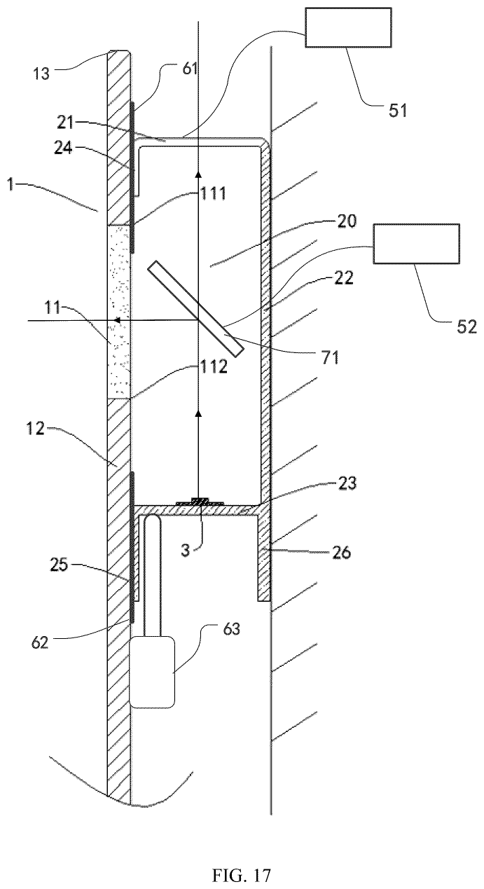

FIG. 17 in a cross-sectional view of a structure of a high brightness lamp mirror of Embodiment 6 of the present application;

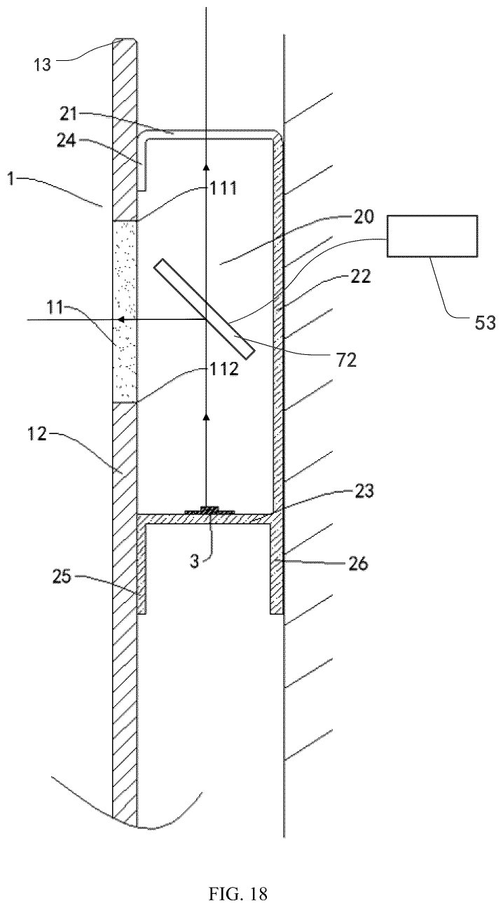

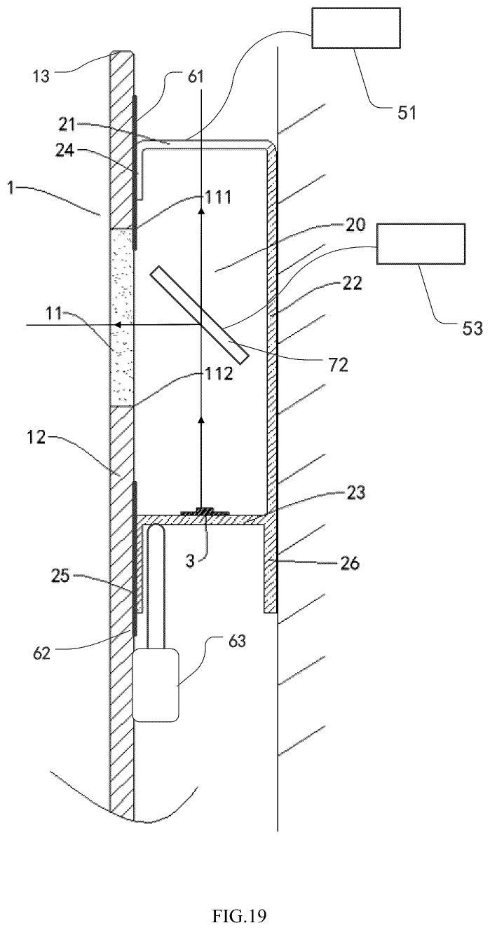

FIG. 18 is a cross-sectional view of a structure of a high brightness lamp mirror in Embodiment 7 of the present application; and

FIG. 19 is a cross-sectional view of a structure of a high brightness lamp mirror in Embodiment 8 of the present application.

### DETAILED DESCRIPTION

### Embodiment 1

Please refer to FIG. 5. A high brightness lamp mirror of the present application includes a mirror body 1, a back light frame 2 and a lamp strip. The back light frame 2 is provided on a back surface of the mirror body 1, the lamp strip is provided in the back light frame 2.

A shape of the mirror body 1 includes but not limited to square, or round, oval, raceway-shaped, irregular-shaped, etc. The mirror body 1 is divided into a light-transmitting area 11 and a reflective area 12. The light-transmitting area 11 may be a hollowed-out transparent structure, or made of transparent glass or light-transmitting frosted glass. A surface frosted structure may increase a scattering angle of a transmitted light beam, so that a light beam transmitted through the mirror body 1 may illuminate a larger area without being overly intense. The reflective area 12 is made of opaque mirrored glass, which reflects light beams incident on its surface, thereby providing a specular reflection function to meet a fundamental mirror-use requirement of users.

Specifically, in one embodiment, the light-transmitting area 11 of the mirror body 1 is provided near a mirror body contour edge 13. At this time, an outer edge 111 of the light-transmitting area 11 is located as close as possible to the mirror body contour edge 13, thereby maximizing a proportion of an area defined by an inner edge 112 of the light-transmitting area 11 to a mirror surface area of the mirror body 1, ensuring the mirror body 1 to have a relatively larger continuous mirror surface to fulfill users' basic mirror-use requirements. The outer edge 111 of the light-transmitting area 11 is an edge of the light-transmitting area 11 near the mirror body contour edge 13, i.e., the boundary line where the light-transmitting area 11 and the reflective area 12 meet near the mirror body contour edge 13. The inner edge 112 of the light-transmitting area 11 is an edge of one side of the light-transmitting area 11 away from the mirror body contour edge 13, i.e., a boundary line where the light-transmitting area 11 and the reflective area 12 meet away from the mirror body contour edge 13. For example, when the mirror body 1 is square, the light-transmitting area 11 is designed as a square frame along the mirror body contour edge 13; when the mirror body 1 is circular, the light-transmitting area 11 is designed as an annular ring along the mirror body contour edge 13, and so on. A center of a shape defined by the inner edge 112 of the light-transmitting area 11 is a central area A of the mirror body 1.

In one embodiment, please refer to FIG. 6; the back light frame 2 includes a top plate 21 and a back plate 22. The top plate 21 is a light-transmissive plate fixed to the back surface of the mirror body 1 and provided between the mirror body contour edge 13 and the outer edge 111 of the light-transmitting area 11 of the mirror body 1. The back plate 22 is connected to the top plate 21. The back plate 22 and the top plate 21 form an integrated light-emitting cavity 20 that covers the entire light-transmitting area 11 of the mirror body 1. A light-emitting opening is provided on one side of the light-emitting cavity 20 near the light-transmitting area 11 of the mirror body 1. At this time, the lamp strip may be provided on the reflective area 12 on a back surface of the mirror body 1 or the back plate 22. Under the condition that the lamp strip is provided on the central area A or a central axis of the mirror body 1, a resulting lighting effect becomes more diffused and uniform. A part of light beams emitted by the lamp strip exits from the light-transmitting area 11 of the mirror body 1 through the light-emitting opening of the light-emitting cavity 20, forming a front lighting effect; another part of light beams emitted by the lamp strip exits from the mirror body contour edge 13 through the top plate 21 along the back surface of the mirror body 1, forming a back lighting effect.

In another embodiment, please refer to FIGS. 7-9; the back light frame 2 includes a top plate 21, a back plate 22 and a bottom plate 23. The top plate 21 is a light-transmissive flat plate fixed on the back surface of the mirror body 1 perpendicularly with a respect to the mirror body 1. The top plate 21 is provided between the mirror body contour edge 13 and the outer edge 111 of the light-transmitting area 11 of the mirror body 1, and is located near the outer edge 111 of the light-transmitting area 11. The bottom plate 23 is also a flat plate fixed to the back surface of the mirror body 1 perpendicularly with a respect to the mirror body 1. The bottom plate 23 is provided between the inner edge 112 of the light-transmitting area 11 of the mirror body 1 and the central area A of the mirror body 1, and is located near the inner edge 112 of the light-transmitting area 11 of the mirror body 1. The back plate 22 is also a flat plate. The back plate 22 is connected to the top plate 21 and the bottom plate 23, forming the light-emitting cavity 20. At this time, the light-emitting opening of the light-emitting cavity 20 substantially corresponds to the light-transmitting area 11 of the mirror body 1. The lamp strip 3 is provided on the bottom plate 23. In this embodiment, a structure of the back light frame 2 may be correspondingly provided according to a zoned design of the light-transmitting area 11 of the mirror body 1. For example, when the light-transmitting area 11 of the mirror body 1 is positioned near the mirror body contour edge 13 and arranged around it, the back light frame 2 also corresponds to a position of the light-transmitting area 11 of the mirror body 1, and the back light frame 2 is provided on the back surface of the mirror body 1 near the mirror body contour edge 13 and is arranged around it. The lamp strip 3 includes a plurality of LED lamp beads, the plurality of LED lamp beads face toward a direction of the top plate 21. A part of light beams emitted by the plurality of LED lamp beads exits from the light-transmitting area 11 of the mirror body 1 through the light-emitting opening of the light-emitting cavity 20, forming the front lighting effect. Another part of the light beams emitted by the plurality of LED lamp beads passing through the light-emitting cavity 20 and transmits through a transparent top plate 21, forming the back lighting effect.

Furthermore, the back light frame 2 further includes a first fixing plate 24, a second fixing plate 25 and a balancing plate 26. The first fixing plate 24 is fixed on an end portion of the top plate 21, and is located at an area between the outer edge 111 of the light-transmitting area 11 of the mirror body 1 and the end portion of the top plate 21. The first fixing plate 24 is closely attached and fixed to the back surface of the mirror body 1, thus enlarging a force-receiving area between the mirror body 1 and the top plate 21. The top plate 21 is fixed and connected to the mirror body 1 through the first fixing plate 24. An arrangement of the first fixing plate 24 ensures that stress applied on the top plate 21 from the mirror body 1 and the back plate 22 is evenly distributed, stress directions on both sides are symmetric along a central axis of the top plate 21, and a resultant stress direction extends from the central area A of the mirror body 1 to the mirror body contour edge 13, which remains within a load-bearing capacity of the top plate 21, preventing fracture or deflection issues. The second fixing plate 25 is fixed on an end portion of the bottom plate 23, and is provided on the central area A of the mirror body 1. The second fixing plate 25 is closely attached and fixed to the back surface of the mirror body 1, thus enlarging a force-receiving area between the mirror body 1 and the bottom plate 23. The bottom plate 23 is fixed and connected to the mirror body 1 through the second fixing plate 25. The balancing plate 26 is provided on an end portion of the back plate 22 connecting to the bottom plate 23. The balancing plate 26 and the second fixing plate 25 directly face each other and are in parallel, thereby enlarging a force-receiving area between the mirror body 1 and the back plate 22. The bottom plate 23 is fixed and connected to the back plate 22 through the balancing plate 26. Similarly, arrangements of the second fixing plate 25 and the balancing plate 26 ensure that stress applied to the bottom plate 23 from the mirror body 1 and the back plate 22 is evenly distributed, stress directions on both sides are symmetric along a central axis of the bottom plate 23, and a resultant stress direction extends from the central area A of the mirror body 1 to the mirror body contour edge 13, which remains within a load-bearing capacity of the bottom plate 23, preventing fracture or deflection issues.

Specifically, the back plate 22 and the bottom plate 23 are made of opaque material. In order to reduce light efficiency loss, surfaces of the back plate 22 and the bottom plate 23 are reflective surfaces, which may reflect a light beam emitted by the lamp strip 3. In one embodiment, mirrored glass is used as the back plate 22 and bottom plate 23 to minimize absorption losses of light.

In actual manufacturing processes, the back light frame 2 may be integrally formed via a two-shot molding process, that is, the bottom plate 23, the back plate 22, the top plate 21, the first fixing plate, the second fixing plate and the balancing are integrated into a single component.

### Embodiment 2

When using the high brightness lamp mirror in Embodiment 1, the inventor discovered that an intensity proportion of the back light to the front light is constant. Even adjusting a brightness of the lamp strip 3 cannot alter the intensity proportion of the back light to the front light. In practice, user requirements for light mirrors are diverse. For example, when an indoor ambient light is too dim, increasing an intensity proportion of the back light is necessary to maintain a stable proportion of the ambient light and the front light entering the human eye, thereby preventing ocular damage. When an outdoor ambient light is too strong, enhancing an intensity proportion of the front light ensures normal mirror functionality without interference from environmental glare. Therefore, in order to enable an adjustment of the intensity proportion of the back light to the front light, Embodiment 2 adds a top plate adjustment unit based on Embodiment 1. A transmittance of the top plate 21 is adjusted by the top plate adjustment unit.

Please refer to FIG. 10. The top plate adjustment unit 51 is provided on one side of the mirror body 1 where the back light frame 2 is installed. The top plate adjustment unit 51 may be controlled via methods such as a mechanical knob or remote control. In one embodiment, the top plate adjustment unit 51 may be a voltage input device such as a transformer or induction coil. At this time, the top plate 21 is correspondingly configured as a liquid crystal panel or electro-optic material. The transformer is connected to the top plate 21 and an external power supply, which may adjust a voltage input to the top plate 21. Specifically, please refer to FIG. 11. When the external power supply is not applied, liquid crystal molecules in the top plate 21 are arranged along a direction parallel to the top plate 21. When the external power supply is applied, the liquid crystal molecules deflect under an action of voltage. A deflection direction of the liquid crystal molecules increases as an input voltage increased, at this time, a transmittance of the top plate 21 increases increases accordingly. Therefore, when a voltage input to the top plate 21 through the transformer increases, the transmittance of the top plate 21 increases. When the transmittance of the top plate 21 increases, the intensity of the front light transmitted through the light-transmitting area 11 decreases, and the intensity of the back light transmitted through the top plate 21 increases, thus increasing the intensity proportion of the back light to the front light. By the above adjustment structure, users may maintain good visual performance even in low ambient light environments, avoiding significant ocular strain or potential damage.

It should be understood that parameters adjusted by the top plate adjustment unit 51 may also be pressure, temperature or magnetic field, etc. It is only required that the top plate 21 meets a condition of being able to adjust its transmittance under certain stimuli, without limiting characteristics of the top plate adjustment unit 51. It should be noted that a specific material of the top plate 21 corresponds to a parameter adjusted by the top plate adjustment unit 51.

For example, when the top plate adjustment unit 51 is a motive device such as a hydraulic press or robotic arm, the top plate 21 is correspondingly configured as a liquid crystal panel or elastic material, etc. The hydraulic press is connected to the top plate 21, which may adjust pressure or stress applied to the top plate 21. Specifically, please refer to FIG. 12. When an external pressure N is not applied, the liquid crystal molecules in the top plate 21 are arranged along the direction parallel to the top plate 21. When the external pressure N is applied, the liquid crystal molecules are deflected under an action of pressure N. A deflection direction of the liquid crystal molecules increases as applied pressure N increases. At this time, the transmittance of the top plate 21 also increases accordingly. Therefore, when a pressure applied to the top plate 21 through the hydraulic press increases, the transmittance of the top plate 21 increases, the intensity of the front light transmitted through the light-transmitting area 11 decreases, while the intensity of the back light transmitted through the top plate 21 increases, thereby increasing the intensity proportion of the back light to the front light.

When the top plate adjustment unit 51 is a thermal control device such as the heater or the electric heating plate, the top plate 21 is correspondingly configured as two-dimensional photonic crystal or thermo-deformation material, etc. The heater may change a temperature of the top plate 21.

Specifically, please refer to FIG. 13, a two-dimensional photonic crystal in the top plate 21 is periodically arranged in a two-dimensional plane. When the temperature of the top plate 21 is increased, gaps between two-dimensional photonic crystals become larger under an action of temperature, and the gaps become larger as the temperature increase within a certain range. At this time, the transmittance of the top plate 21 also increases accordingly.

Therefore, when the temperature of the top plate 21 is increased through the heater, the transmittance of the top plate 21 increases, the intensity of the front light transmitted through the light-transmitting area 11 decreases, while the intensity of the back light transmitted through the top plate 21 increases, thereby increasing the intensity proportion of the back light to the front light.

### Embodiment 3

Based on Embodiment 1 of the present application, Embodiment 3 adds a displacement unit, which enables the back light frame 2 to move back and forth between the outer edge 111 and the inner edge 112 of the light-transmitting area 11 of the mirror body 1 through the displacement unit, thereby achieving an adjustment of the intensity proportion of the back light to the front light.

Please refer to FIG. 14. The displacement unit 60 includes a top plate sliding rail 61 and a bottom plate sliding rail 62, both fixed on the back surface of the mirror body 1, and a driving motor 63. The top plate 21 is provided on the top plate sliding rail 61, the bottom plate 23 is provided on the bottom plate sliding rail 62. The driving motor 63 simultaneously drives the top plate 21 to move along the top plate sliding rail 61 and the bottom plate 23 to move along the bottom plate sliding rail 62.

In one embodiment, a positioning block is provided on both ends of the top plate sliding rail 61 and the bottom plate sliding rail 62, ensuring that the back light frame 2 does not disengage during the back and forth movement, and the light-transmitting area 11 of the mirror body 1 always remains within the light-emitting opening of the light-emitting cavity 20. In addition, the first fixing plate 24 is provided on the top plate sliding rail 61, and the second fixing plate 25 is provided on the bottom plate sliding rail 62. The first fixing plate 24 is in abutting connection to the top plate sliding rail 61 rather than being fixedly connected, and the second fixing plate 25 is in abutting connection to the bottom plate sliding rail 62 rather than being fixedly connected. This ensures that the back light frame 2 may move relative to the mirror body 1 while maintaining a sealing of the light-emitting cavity 20, thus preventing light leakage issues.

Specifically, when the top plate 21 is controlled to move to the mirror body contour edge 13, the intensity of the front light transmitted through the light-transmitting area 11 is decreased, while the intensity of the back light transmitted through the top plate 21 is increased, thus increasing the intensity proportion of the back light to the front light. By the above adjustment structure, users may maintain good visual performance even in low ambient light environments, avoiding significant ocular strain or potential damage. Compared with Embodiment 2, an adjustment method in Embodiment 3 does not require continuous voltage input to the top plate 21, which may save power and reduce manufacturing costs.

It should be understood that the displacement unit 60 may also use other mechanisms to move the back light frame 2, and its specific structure is not limited here. It should be noted that an arrangement of the displacement unit 60 is designed for mirror bodies 1 with a long strip-shaped light-transmitting area 11, a square frame-shaped light-transmitting area 11 or a rectangle frame-shaped light-transmitting area 11. For mirror bodies 1 with light-transmitting area 11 of other shapes, the displacement unit 60 only has a function of adjusting the intensity proportion of the back light to the front light in a moving direction of the back light frame 2.

### Embodiment 4

During a practical application of Embodiment 2 and Embodiment 3, the inventor discovered that two different methods for adjusting the intensity proportion of the back light to the front light in Embodiment 2 and Embodiment 3 is at different levels and may be simultaneously employed to expand an adjustment range and enhance a precision of the intensity proportion of the back light to the front light. Therefore, Embodiment 4 combines Embodiment 2 and Embodiment 3, the transmittance of the top plate 21 is adjusted through the top plate adjustment unit 51, and the back light frame 2 is moved back and forth between the outer edge 111 and the inner edge 112 of the light-transmitting area 11 of the mirror body 1 through the displacement unit 60.

Please refer to FIG. 15. The top plate adjustment unit 51 is provided on one side of the mirror body 1 where the back light frame 2 is installed. The top plate adjustment unit 51 may be controlled via methods such as a mechanical knob or remote control. Specifically, when the transmittance of the top plate 21 increases, the intensity of the front light transmitted through the light-transmitting area 11 decreases, while the intensity of the back light transmitted through the top plate 21 increases, thus increasing the intensity proportion of the back light to the front light.

The displacement unit 60 includes the top plate sliding rail 61 and the bottom plate sliding rail 62, both fixed on the back surface of the mirror body 1, and the driving motor 63. The top plate 21 is provided on the top plate sliding rail 61, the bottom plate 23 is provided on the bottom plate sliding rail 62. The driving motor 63 simultaneously drives the top plate 21 to move along the top plate sliding rail 61 and the bottom plate 23 to move along the bottom plate sliding rail 62. Specifically, when the top plate 21 is controlled to move to the mirror body contour edge 13, the intensity of the front light transmitted through the light-transmitting area 11 is decreased, while the intensity of the back light transmitted through the top plate 21 is increased, thus increasing the intensity proportion of the back light to the front light.

By the above adjustment structure, users may maintain good visual performance even in low ambient light environments, avoiding significant ocular strain or even potential damage. It can be understood that by simultaneously adjusting the transmittance of the top plate 21 and a position of the back light frame 2, a wider range of a proportion adjustment may be achieved, and an adjustment precision is improved, providing users with more options during actual use.

### Embodiment 5

Base on Embodiment 1 of the present application, Embodiment 5 adds an energy beam splitter and a light splitting adjustment unit. The light splitting adjustment unit adjusts an energy proportion of split light from the energy beam splitter, thereby enabling an adjustment of the intensity proportion of the back light to the front light. The energy beam splitter is a standard splitter, which may reflect and transmit incident light beams at a certain ratio.

Please refer to FIG. 16. The energy beam splitter 71 is provided in the light-emitting cavity 20. A Light beam emitted by the lamp strip 3 with a part of energy is reflected by the energy beam splitter 71 and exits from the light-transmitting area 11 of the mirror body 1 through the light-emitting opening, forming the front lighting effect. Simultaneously, a light beam emitted by the lamp strip 3 with a remaining part of energy transmits through the energy beam splitter 71 and exits from the mirror body contour edge 13 through the top plate 21 along the back surface of the mirror body 1, forming the back lighting effect. The light splitting adjustment unit 52 is provided on one side of the mirror body 1 where the back light frame 2 is installed. The light splitting adjustment unit 52 may be controlled via methods such as a mechanical knob or remote control, thereby controlling a change of an energy proportion of split light from the energy beam splitter 71 to adjust the intensity proportion of the back light to the front light. Its mechanism is identical to a transmittance control of the top plate 21 by the top plate adjustment unit 51 in Embodiment 2. The light splitting adjustment unit 52 may be a power device such as a hydraulic press or robotic arm. At this time, the energy beam splitter 71 is correspondingly configured as a liquid crystal panel or an elastic material, etc. The hydraulic press is connected to an external power supply, which may adjust a pressure or a stress applied on the energy beam splitter 71. Specifically, when a pressure applied by the hydraulic press to the energy beam splitter 71 increases, a transmittance of the energy beam splitter 71 increases. At this time, the intensity of the front light transmitted through the light-transmitting area 11 decreases, while the intensity of the back light transmitted through the top plate 21 increases, thus increasing the intensity proportion of the back light to the front light.

By the above adjustment structure, users may maintain good visual performance even in low ambient light environments, avoiding significant ocular strain or potential damage. Compared with Embodiments 2, 3, and 4, Embodiment 5 shifts an adjustment target from the top plate 21 or back light frame 2, which are directly contact with an external environment, to the energy beam splitter 71 enclosed within the light-emitting cavity 20. This enhances wear resistance and safety of the high brightness lamp mirror in the present application, thereby preventing failure of an adjustment function of the intensity proportion of the back light to the front light due to collisions and friction between the back light frame 2 and external objects, as well as electrical leakage and other safety hazards.

It can be understood that parameters adjusted by the light splitting adjustment unit 52 may also include voltage, temperature, etc. At this time, the energy beam splitter 71 is changed accordingly to enable its proportion of transmission to reflection to be adjusted with parameter variations of the light splitting adjustment unit 52. For example, when the light splitting adjustment unit 52 is the voltage input device such as the transformer or the induction coil, the energy beam splitter 71 is correspondingly configure as the liquid crystal panel or electro-optic material. The transformer is connected to the energy beam splitter 71 and the external power supply, which may adjust a voltage passing through the energy beam splitter 71. When a voltage input to the energy beam splitter 71 through the transformer increases, a transmittance of the energy beam splitter 71 increases, the intensity of the front light transmitted through the light-transmitting area 11 decreases, and the intensity of the back light transmitted through the top plate 21 increases, thus increasing the intensity proportion of the back light to the front light. When the light splitting adjustment unit 52 is the thermal control device such as the heater or the electric heating plate, the energy beam splitter 71 is correspondingly made of a two-dimensional photonic crystal or thermo-deformation material, etc. The heater may change a temperature of the energy beam splitter 71. When the temperature of the energy beam splitter 71 is increased by the heater, the transmittance of the energy beam splitter 71 increases, the intensity of the front light transmitted through the light-transmitting area 11 decreases, and the intensity of the back light transmitted through the top plate 21 increases, thus increasing the intensity proportion of the back light to the front light.

### Embodiment 6

During practical use of Embodiment 2 and Embodiment 5, the inventor found that adjustment methods of the intensity proportion of the back light to the front light in Embodiment 2 and Embodiment 5 are at different levels, and may be simultaneously employed to expand an adjustment range and a precision of the intensity proportion of the back light to the front light. Therefore, Embodiment 6 combines Embodiment 2 and Embodiment 5. The top plate adjustment unit 51 is used to adjust the transmittance of the top plate 21 and the light splitting adjustment unit 52 is used to adjust the energy proportion of split light from the energy beam splitter 71.

Please refer to FIG. 17. The top plate adjustment unit 51 is provided on one side of the mirror body 1 where the back light frame 2 is installed. The top plate adjustment unit 51 may be controlled via methods such as a mechanical knob or remote control. Specifically, when the transmittance of the top plate 21 increases, the intensity of the front light transmitted through the light-transmitting area 11 decreases, and the intensity of the back light transmitted through the top plate 21 increases, thus increasing the intensity proportion of the back light to the front light.

The energy beam splitter 71 is provided in the light-emitting cavity 20. A Light beam emitted by the lamp strip 3 with a part of energy is reflected by the energy beam splitter 71 and exits from the light-transmitting area 11 of the mirror body 1 through the light-emitting opening, forming the front light emitting effect. Simultaneously, a light beam emitted by the lamp strip with a remaining part of energy transmits through the energy beam splitter 71 and exits from the mirror body contour edge 13 through the top plate 21 along the back surface of the mirror body 1, forming the back lighting effect. The light splitting adjustment unit 52 is provided on one side of the mirror body 1 where the back light frame 2 is installed. The light splitting adjustment unit 52 may be controlled via methods such as a mechanical knob or remote control, thereby controlling the change of the energy proportion of split light from the energy beam splitter 71 to adjust the intensity proportion of the back light to the front light. Specifically, when the transmittance of the energy beam splitter 71 increases, the intensity of the front light transmitted through the light-transmitting area 11 decreases, and the intensity of the back light transmitted through the top plate 21 increases, thus increasing the intensity proportion of the back light to the front light.

By the above adjustment structure, users may maintain good visual performance even in low ambient light environments, avoiding significant ocular strain or potential damage. Compared with Embodiments 2, 3, and 4, Embodiment 6 shifts an adjustment target from the top plate 21 or back light frame 2, which are directly contact with an external environment, to the energy beam splitter 71 enclosed within the light-emitting cavity 20. This enhances wear resistance and safety of the high brightness lamp mirror of the present application, thereby preventing failure of the adjustment function of the intensity proportion of the back light to the front light due to collisions and friction between the back light frame 2 and external objects, as well as electrical leakage and other safety hazards.

At the same time, compared with Embodiment 5, Embodiment 6 combines an adjustment function for the intensity proportion of the back light to the front light at another level, thus enhancing the adjustment range and the precision for the intensity proportion of the back light to the front light.

### Embodiment 7

When using the high brightness lamp mirror in Embodiment 1, the inventor discovered that colors of the back light and front light are fixed and identical. Even when adjusting a brightness of the lamp strip 3, the colors of the back light and the front light cannot be adjusted. In practice, user demands for lamp mirrors vary. For example, during festive events, warm color front light is needed to create a warm and harmonious atmosphere; while cool color front light is required for filming or live-streaming formal announcements or warnings to match solemn occasions. Therefore, in order to enable an adjustment of the colors of the back light and the front light, Embodiment 7 adds a wavelength beam splitter and a wavelength adjustment unit based on Embodiment 1. A wavelength selection range of the wavelength beam splitter is controlled by the wavelength adjustment unit.

Please refer to FIG. 18. The wavelength beam splitter 72 is provided in the light-emitting cavity 20.

A Light beam emitted by the lamp strip 3 with a part of wavelengths is reflected by the wavelength beam splitter 72 and exits from the light-transmitting area 11 of the mirror body 1 through the light-emitting opening, forming the front light emitting effect. Simultaneously, a light beam emitted by the lamp strip with a remaining part of wavelengths transmits through the wavelength beam splitter 72 and exits from the mirror body contour edge 13 through the top plate 21 along the back surface of the mirror body 1, forming the back lighting effect. Therefore, the front light and the back light may present different colors, meeting specific ambiance requirements of practical scenarios.

The wavelength adjustment unit 53 is provided on one side of the mirror body 1 where the back light frame 2 is installed. The wavelength adjustment unit 53 may be controlled via methods such as a mechanical knob or remote control, thereby controlling the wavelength selection range of the wavelength beam splitter 72 to adjust colors respectively presented by the front light and the back light, making it applicable to different atmospheres and requirements in practical scenarios. For example, when taking artistic photos, a wavelength range reflected by the wavelength beam splitter 72 may be adjusted to long wavelengths of visible light, thereby obtaining warm color front light; when taking cinematic realistic photos, the wavelength range reflected by the wavelength beam splitter 72 may be adjusted to short wavelengths of visible light, thereby obtaining cool color front light.

Specifically, the wavelength adjustment unit 53 may be a thermal control device such as the heater or the electric heating plate, and the wavelength beam splitter 72 is a thermally variable optical material such as an optical film. The heater may adjust a temperature of the wavelength beam splitter 72. When the temperature of the wavelength beam splitter 72 is increased by the heater, a molecular density of the optical film decreases, narrowing a wavelength range reflected by the wavelength beam splitter 72. This causes a color of the front light transmitted through the light-transmitting area 11 to shift toward a cool color. And a wavelength range transmitted through the wavelength beam splitter 72 expands, a color of the back light shifts toward a warm color, thereby adjusting a color presentation of both the back light and the front light.

### Embodiment 8

During actual use of Embodiment 2, Embodiment 3 and Embodiment 7, the inventor observed that adjustments of the intensity proportion of the back light to the front light in these three embodiments are at different levels. They may be employed simultaneously to expand an adjustment range and a precision of the intensity proportion of the back light to the front light while concurrently controlling the colors of both the front light and the back light. Therefore, Embodiment 8 combines Embodiment 2, Embodiment 3 and Embodiment 7. By adjusting the transmittance of the top plate 21 through the top plate adjustment unit 51, adjusting an energy splitting proportion of split light from the energy beam splitter 71 through the beam splitting adjustment unit 52, and controlling the wavelength selection range of the wavelength beam splitter 72 through the wavelength adjustment unit 53, it achieves adjustments of both the intensity proportion of the back light to the front light and color presentation of the back light and the front light.

Please refer to FIG. 19. The top plate adjustment unit 51 is arranged on one side of the mirror body 1 where the back light frame 2 is installed. The top plate adjustment unit 51 may be controlled through methods such as the mechanical knob or the remote control. Specifically, when the transmittance of the top plate 21 increases, the intensity of front light transmitted through the light-transmitting area 11 decreases, while the intensity of the back light transmitted through the top plate 21 increases, thereby increasing the intensity proportion of the back light to the front light.

The displacement unit 60 includes the top plate sliding rail 61 and the bottom plate sliding rail 62, both fixed to the back surface of the mirror body 1, and the driving motor 63. The top plate 21 is provided on the top plate sliding rail 61, the bottom plate 23 is provided on the bottom plate sliding rail 62, and the driving motor 63 simultaneously drives the top plate 21 to move along the top plate sliding rail 61 and the bottom plate 23 to move along the bottom plate sliding rail 62. Specifically, when the top plate 21 is controlled to move toward the mirror body contour edge 13, the intensity of front light transmitted through the light-transmitting area 11 decreases, while the intensity of the back light transmitted through the top plate 21 increases, thereby increasing the intensity proportion of the back light to the front light.

The wavelength beam splitter 72 is provided in the light-emitting cavity 20. A Light beam emitted by the lamp strip 3 with a part of wavelengths is reflected by the wavelength beam splitter 72 and exits from the light-transmitting area 11 of the mirror body 1 through the light-emitting opening, forming the front light emitting effect. Simultaneously, a light beam emitted by the lamp strip with a remaining part of wavelengths transmits through the wavelength beam splitter 72 and exits from the mirror body contour edge 13 through the top plate 21 along the back surface of the mirror body 1, forming the back lighting effect.

The wavelength adjustment unit 53 is provided on one side of the mirror body 1 where the back light frame 2 is installed. The wavelength adjustment unit 53 may be controlled via methods such as the mechanical knob or the remote control to adjust the wavelength selection range of the wavelength beam splitter 72, thereby adjusting presented colors of both the front light and the back light to suit different atmospheres and requirements in practical scenarios. Specifically, when the wavelength range reflected by the wavelength beam splitter 72 narrows, the color of the front light transmitted through the light-transmitting area 11 shifts toward the cool color, while the wavelength range transmitted through the wavelength beam splitter 72 expands, the color of the back light shifts toward the warm color, thereby adjusting the colors respectively presented by the back light and the front light.

Through above adjustment mechanisms, the high brightness lamp mirror of the present application not only enables real-time changes to the colors of the front light and the back light, but also concurrently adjusts the intensity proportion of the front light to the back light. Compared with Embodiment 1, an adjustment range is doubled, allowing a presentation of colors such as bright green and dark green that existing mirrors cannot achieve, thereby enabling a selection of any color gamut. This ensures users maintain optimal visual experiences even under extreme ambient lighting conditions such as excessive brightness or darkness without causing significant eye strain or damage, while offering corresponding solutions for diverse atmospheric requirements.

With a design of the back plate, the high brightness lamp mirror of the present application enables one lamp strip to simultaneously generate the front light and the back light for the mirror body, thereby significantly enhancing luminous efficacy of a lamp mirror while reducing manufacturing costs. Furthermore, by setting adjustable parameters for each component, the intensity of the back light to the front light produced by the light strip 3 becomes controllable. Additionally, the colors of the back light and the front light generated by the light strip 3 is controllable, which is more adaptable to various scenarios and daily needs.

The above-mentioned embodiments merely represent several embodiments of the present application, and the description thereof is more specific and detailed, but it should not be construed as limiting the scope of the present application. It should be noted that, for those skilled in the art, several variations and improvements may be made without departing from the concept of the present application, and these are all within the protection scope of the present application.

What is claimed:

1. A high brightness lamp mirror, comprising:
a mirror body, wherein a light-transmitting area is provided on the mirror body;
a back light frame provided on a back surface of the mirror body, wherein, the back light frame includes a top plate and a back plate; the top plate is a light-transmissive plate, the top plate is provided between a mirror body contour edge and an outer edge of the light-transmitting area of the mirror body; the back plate is connected to the top plate, the top plate and the back plate form a light-emitting cavity covering the mirror body, a light-emitting opening is provided on one side of the light-emitting cavity near the mirror body;
a lamp strip provided in the light-emitting cavity of the back light frame; wherein, a part of light beams emitted by the lamp strip exits from the light-transmitting area of the mirror body through the light-emitting opening, forming a front lighting effect; and another part of the light beams emitted by the lamp strip exits from the mirror body contour edge through the top plate along the back surface of the mirror body, forming a back lighting effect.

2. The high brightness lamp mirror of claim 1, wherein, the back light frame further includes a bottom plate, the bottom plate is provided between an inner edge of the light-transmitting area of the mirror body and a central area of the mirror body, the back plate is connected to the top plate and the bottom plate to form a light-emitting cavity with the light-emitting opening that only faces the light-transmitting area of the mirror body; the lamp strip is provided on the bottom plate.

3. The high brightness lamp mirror of claim 2, wherein, the light-transmitting area of the mirror body is provided near the mirror body contour edge and is arranged around the mirror body; the bottom plate and the top plate of the back light frame are perpendicular to the mirror body, the back plate of the back light frame is parallel to the mirror body, the back light frame is configured to cover the light-transmitting area of the mirror body to forma light-emitting cavity that surrounds the light-transmitting area.

4. The high brightness lamp mirror of claim 2, wherein, a first fixing plate is provided on an end portion of the top plate, the first fixing plate is provided between the top plate and the outer edge of the light-transmitting area of the mirror body, the first fixing plate is closely attached and fixed to the mirror body; a second fixing plate is provided on an end portion of the bottom plate, the second fixing plate is provided on the central area of the mirror body, the second fixing plate is closely attached and fixed to the mirror body; a balancing plate is provided on an end portion of the back plate connected to the bottom plate, the balancing plate and the second fixing plate directly face each other and are in parallel.

5. The high brightness lamp mirror of claim 1, further comprising: a top plate adjustment unit, wherein, the top plate adjustment unit is configured to control a change of a transmittance of the top plate to adjust an intensity proportion of back light to front light.

6. The high brightness lamp mirror of claim 5, wherein, the top plate adjustment unit is a transformer, the top plate is a liquid crystal panel, when a voltage input to the top plate through the transformer increases, the transmittance of the top plate increases; or, the top plate adjustment unit is a hydraulic press, the top plate is a liquid crystal panel, when a pressure applied to the top plate through the hydraulic press increases, the transmittance of the top plate increases; or, the top plate adjustment unit is a heater, the top plate is a two-dimensional photonic crystal, when the heater controls a temperature of the top plate to increase, the transmittance of the top plate increases.

7. The high brightness lamp mirror of claim 2, further comprising: a displacement unit, wherein, the displacement unit is configured to control the back light frame to move back and forth between the inner edge and the outer edge of the light-transmitting area of the mirror body to adjust an intensity proportion of back light to front light.

8. The high brightness lamp mirror of claim 7, wherein, the displacement unit includes a top plate sliding rail and a bottom plate sliding rail, both fixed on the back surface of the mirror body, and a driving motor; the top plate is provided on the top plate sliding rail, the bottom plate is provided on the bottom plate sliding rail, the driving motor simultaneously drives the top plate to move along the top plate sliding rail and the bottom plate to move along the bottom plate sliding rail.

9. The high brightness lamp mirror of claim 8, further comprising: a top plate adjustment unit, wherein, the top plate adjustment unit is configured to control a change of a transmittance of the top plate to adjust the intensity proportion of the back light to the front light.

10. The high brightness lamp mirror of claim 1, further comprising:
an energy beam splitter provided in the light-emitting cavity, wherein, a light beam with a part of energy emitted by the lamp strip is reflected by the energy beam splitter and exits from the light-transmitting area of the mirror body through the light-emitting opening, forming the front lighting effect; at the same time, a light beam with a remaining part of energy emitted by the lamp strip transmits through the energy beam splitter and exits from the mirror body contour edge through the top plate along the back surface of the mirror body, forming the back lighting effect;
a light splitting adjustment unit, wherein, the light splitting adjustment unit controls a change of an energy proportion of split light from the energy beam splitter to adjust an intensity proportion of front light to back light.

11. The high brightness lamp mirror of claim 5, further comprising:
an energy beam splitter provided in the light-emitting cavity, wherein, a light beam with a part of energy emitted by the lamp strip is reflected by the energy beam splitter and exits from the light-transmitting area of the mirror body through the light-emitting opening, forming the front lighting effect; at the same time, a light beam with a remaining part of energy emitted by the lamp strip transmits through the energy beam splitter and exits from the mirror body contour edge through the top plate along the back surface of the mirror body, forming the back lighting effect;
a light splitting adjustment unit, wherein, the light splitting adjustment unit controls a change of an energy proportion of split light from the energy beam splitter to adjust the intensity proportion of the front light and the back light.

12. The high brightness lamp mirror of claim 1, further comprising:
a wavelength beam splitter provided in the light-emitting cavity, wherein, a light beam with a part of wavelengths emitted by the lamp strip is reflected by the wavelength beam splitter and exits from the light-transmitting area of the mirror body through the light-emitting opening, forming the front lighting effect; at the same time, a light beam with a remaining part of wavelengths emitted by the lamp strip transmits through the wavelength beam splitter and exits from the mirror body contour edge through the top plate along the back surface of the mirror body, forming the back lighting effect;
a wavelength adjustment unit, wherein, the wavelength adjustment unit controls a wavelength selection range of the wavelength beam splitter to adjust colors respectively presented by back light and front light.

13. The high brightness lamp mirror of claim 2, further comprising:
a displacement unit, wherein, the displacement unit is configured to control the back light frame to move back and forth between the inner edge and the outer edge of the light-transmitting area of the mirror body to adjust an intensity proportion of back light to front light;
a wavelength beam splitter provided in the light-emitting cavity, wherein, a light beam with a part of wavelengths emitted by the lamp strip is reflected by the wavelength beam splitter and exits from the light-transmitting area of the mirror body through the light-emitting opening, forming the front lighting effect; at the same time, a light beam with a remaining part of wavelengths emitted by the lamp strip transmits through the wavelength beam splitter and exits from the mirror body contour edge through the top plate along the back surface of the mirror body, forming the back lighting effect;
a top plate adjustment unit, wherein, the top plate adjustment unit controls a change of a transmittance of the top plate to adjust the intensity proportion of the back light to the front light; and
a wavelength adjustment unit, wherein, the wavelength adjustment unit controls a wavelength selection range of the wavelength beam splitter to adjust colors respectively presented by the back light and the front light.

14. The high brightness lamp mirror of claim 13, wherein, the top plate adjustment unit is a transformer, the top plate is a liquid crystal panel, when a voltage input to the top plate through the transformer increases, the transmittance of the top plate increases; or, the top plate adjustment unit is a hydraulic press, the top plate is a liquid crystal panel, when a pressure applied to the top plate through the hydraulic press increases, the transmittance of the top plate increases; or, the top plate adjustment unit is a heater, the top plate is a two-dimensional photonic crystal, when the heater controls a temperature of the top plate to increase, the transmittance of the top plate increases.

15. The high brightness lamp mirror of claim 13, wherein, the displacement unit includes a top plate sliding rail and a bottom plate sliding rail, both fixed on the back surface of the mirror body, and a driving motor; the top plate is provided on the top plate sliding rail, the bottom plate is provided on the bottom plate sliding rail, the driving motor simultaneously drives the top plate to move along the top plate sliding rail and the bottom plate to move along the bottom plate sliding rail.
